(19) United States
(12) Patent Application Publication
(10) Pub. No.: US 2005/0237887 A1
(43) Pub. Date: Oct. 27, 2005

(54) Method of providing copy protection for optical storage media

(76) Inventor: Bradley Thomas Collar, Valencia, CA (US)

Correspondence Address: GOTTLIEB RACKMAN & REISMAN PC, 270 MADISON AVENUE, 8TH FLOOR, NEW YORK, NY, 100160601, US

(21) Appl. No.: 11/088,336

(22) Filed: Mar. 24, 2005

Related U.S. Application Data
(60) Provisional application No. 60/556,914, filed on Mar. 26, 2004.
(60) Provisional application No. 60/556,849, filed on Mar. 26, 2004.

(51) Int. Cl. G11B 7/007

(52) U.S. Cl. 369/53.21; 369/47.12; 369/47.55

(57) ABSTRACT

Disc burner software is known that generates only a second generation disc from an original or first generation disc by adding to the second generation a copy protection indication. According to the present invention, an original disc includes normal program files, and in addition, also includes the copy protection indication. When an attempt is made to copy such a disc using the disc burner software, the software will not make a second generation copy because it will mistakenly identify the original disc as a copy.

### RELATED APPLICATIONS

This application claims priority to Provisional Application Ser. No. 60/556,914 filed Mar. 26, 2004, and incorporated herein by reference.

The subject matter of this application is also related to application Ser. No. ______ filed ______ which claims priority to U.S. Provisional Application Ser. No. 60/556,849 filed Mar. 26, 2004 and incorporated herein by reference.

### BACKGROUND OF THE INVENTION

1. Field of the Invention

This invention pertains to a method of preventing the copying of an optical storage medium on a copying device such as a CD, DVD or other optical disc burner.

2. Description of the Prior Art

An optical disc, such as a CD, DVD, HD-DVD or Blu-ray Disc (collectively “DVD”), has a very large digital data storage capacity. At first, the making of DVDs was a complicated process and DVDs could be made only in special pressing plants. However, devices known as DVD burners have become available that can write data on blank (recordable) DVD discs. Some DVD burner software allows a user to make an unauthorized copy on a recordable DVD of the programming content of an original or prerecorded DVD. Although certain prerecorded DVDs have anti-copying protection, such as CSS, that anti-copying mechanism has been compromised.

At least one company, 321 Studios of St. Charles, Mo., is or was selling software called DVD X-COPY that can be used to make a second generation copy of an original DVD. The software, however, will not make additional copies from the second generation copy. The reasoning (albeit a flawed one) is that one archival copy should be allowed, but not rampant copying. This is obviously unsatisfactory because an unlimited number of second generation copies can be made from the first generation original pressed disc.

### SUMMARY OF THE INVENTION

Briefly, in the situation where DVD copying software will not make a copy of what it perceives to be an archival copy of a DVD, the present invention involves modifying or formatting an original or first generation disc such that the DVD copying software perceives the DVD to be a second generation disc that was made by copying an original DVD. The software therefore will not copy even an original first generation disc. The original DVD adheres to all of the relevant DVD specifications and, accordingly, its contents can be reproduced by any standard player. However, any attempt by a user to copy this original or prerecorded DVD on a DVD burner using software such as DVD X-COPY will not be successful.

### DESCRIPTION OF THE DRAWINGS

FIG. 1 shows how data is organized on a prior art first generation DVD;

FIG. 2 shows how a first generation DVD is burned using existing software;

FIG. 3 shows how data is organized on a prior art first generation DVD; and

FIG. 4 shows how data is organized on a first generation DVD in accordance with this invention.

### DETAILED DESCRIPTION OF THE PREFERRED EMBODIMENT

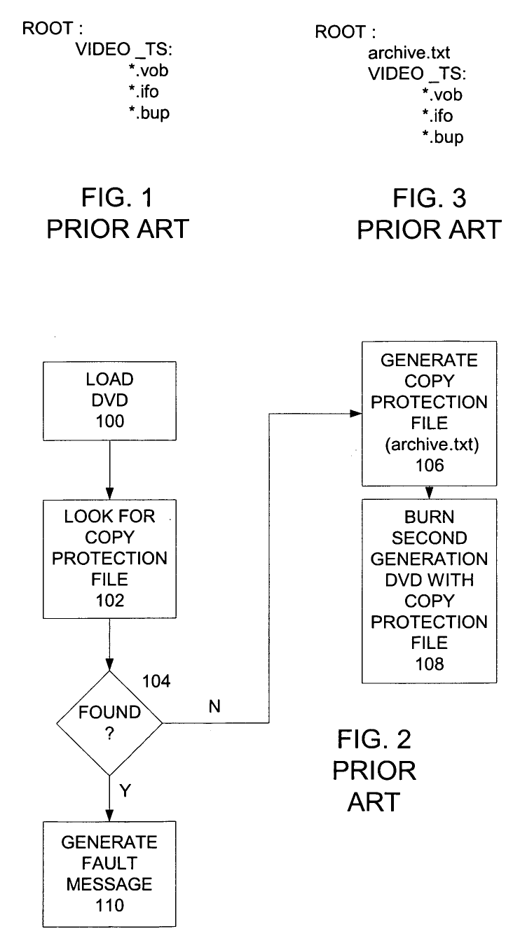

As shown in FIG. 1, typically a prerecorded or pressed DVD, like most other types of data storage media, has data files organized in a hierarchical directory system. More specifically, an original DVD has a ROOT directory with a VIDEO_TS subdirectory. The VIDEO_TS subdirectory includes the normal components of a multimedia presentation, such as video object files identified as *.vob, navigational information files identified as *.ifo, and backup files, identified as *.bup. In the present application, this type of disc is referred to as an original or first generation disc.

As discussed above, the DVD X-COPY software can be used to make second generation DVDs, but not third generation DVDs (where the second generation DVD is made by DVD X-Copy). The operation of a DVD burner controlled by this program is described by the flow chart of FIG. 2. (The flow chart depicts only the steps necessary to understand the invention, and omits the usual steps for playing a DVD disc.) In step 100, the original DVD is loaded into the DVD burner. In step 102, the program looks for a copy protection file. The copy protection file is one that the software itself writes to a recordable disc when making a second generation copy of an original disc (see step 106 below). Therefore, the copy protection file is not found on a standard original disc.

If no file is found in step 104, then the making of a disc copy is permitted. In step 106 a copy protection indication file is generated. The file may include some standard text and information indicating what software was used, the software version, the date on which the file was generated, flags indicating rules governing whether the file can be copied (e.g., “copy never,” “copy once,” “unrestricted copying”) etc. Alternatively, the copy protection file can even contain no information in the case where (as in the case of DVD X-COPY) the software merely looks for the file's presence (in step 104), but not any specific content of the file. In the case of DVD X-COPY, the software calls this file “archive.txt”. In step 108, the contents of the original DVD are copied on a recordable DVD to make the second generation copy. The copy protection file archive.txt is created and recorded on the second generation copy.

FIG. 3 shows the data on the second generation DVD. In the case of DVD X-Copy, the copy protection file (archive.txt) is shown in the ROOT directory. Obviously, this or similar files can be placed anywhere else on the DVD as well so long as the playback of the DVD on a standard player device will not be impaired.

Referring back to FIG. 2, when a second generation DVD is inserted into the DVD burner, in step 104 the copy protection file is found. Then in step 110 the software generates a fault message indicating that copying of this DVD is not permitted, and the software will not copy the DVD.

As discussed above, the overall sequencing does not prevent a user from making multiple second generation DVDs from an original DVD. Moreover, most distributors of content on original DVD-ROM and DVD-Video discs do not want even a single second generation copy to be made. Therefore, according to my invention, an original DVD is made in a way that it is mistakenly recognized by copying software, such as DVD X-COPY, as being a second generation DVD (even though it is really a first generation) and will not make a copy of it.

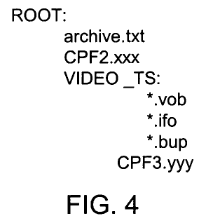

More particularly, as shown in FIG. 4, an original DVD is produced that includes in its ROOT directory (but may also be located in some other location so long as playback is not affected) a copy protection file, such as archive.txt, as well as the other standard files in the VIDEO_TS directory. When this first generation DVD is inserted into the DVD burner, the software finds the copy protection file in step 104 and therefore handles it as a second generation recordable DVD and will not copy it. Typically, the copy protection file (or files if multiple copying programs are to be foiled) is inserted during the disc authoring process and is thereafter incorporated on each original disc through replication.

In the most recent version of DVD X-COPY, the contents of the file archive.txt do not matter. If in future versions, or in different disc copying products, the contents of the file do become material, the copy protection file impressed on the first generation DVD should satisfy whatever the software's requirement is for indicating that the DVD is a copy. Moreover, the copy protection file could have other formats as well. For example, the file could be a binary file. In one embodiment of the invention, this binary file contains only binary zeros.

As discussed above, the program DVD X-COPY looks for the copy protection file archive.txt in the root directory. Other software programs may be provided that may look for a different copy protection file, such as CPF2.xxx in the ROOT directory, or CPF3.yyy in the VIDEO_TS directory. Therefore an original DVD can include these files as well, as shown in FIG. 4. As new software is written to copy DVDs, if it writes on a copy some indication that the disc is a copy of an original and should not be copied, then that software can be foiled from making even a second generation copy simply by including that indication on an original disc. As should be apparent, discs can contain multiple copy protection files on a single disc to foil a wide variety of disc copying software programs which, individually, rely on the presence or absence of different copy protection files in determining whether an archive copy is permitted.

Numerous modifications may be made to the invention without departing from its scope as defined in the appended claims.

1. A method for causing DVD copying software that normally copies first generation discs but not second generation discs not to copy even first generation discs, said DVD copying software placing on a copy that it makes an indication that the disc is a copy and said DVD copying software further looking for that indication on any disc that it is called upon to copy and not copying the disc if the indication is present, comprising placing said indication on first generation discs so that the software mistakenly determines that the disc to be a second generation copy.

2. A method of preventing copying an original disc on a device adapted to generate only a second generation copy from a first generation disc by adding a copy protection indication on the second generation copy comprising the step of producing said original disc with said copy protection indication.

3. The method of claim 2 wherein said copy protection indication is one of a plain text file and a file stored in binary format.

4. The method of claim 3 wherein said plain text file is an empty plain text file.

5. The method of claim 3 wherein said copy protection indication is a file stored in binary format that contains all zeros.

6. A method of preventing copying of an original disc comprising:
Identifying one or more copy protection indicators that will prevent the copying of original discs by disc copying software if the presence of such copy protection indicators is detected; and
placing such copy protection indicators on original discs such that disc copying software will detect such copy protection indicators and as a result of such detection not copy said original disc.

7. An original disc comprising:
a content directory with a plurality of content files; and
a copy protection indication having characteristics that misidentify the original disc as a second generation disc to prevent the original disc from being used to generate a second generation disc on a disc burner arranged to make only second generation copies.

8. The disc of claim 7 wherein said copy protection indication is one of a plain text file and a file stored in binary format.

9. The disc of claim 7 wherein said copy protection indication is an empty plain text file.

10. The disc of claim 7 wherein said copy protection indication is a file stored in binary format that contains all zeros.
